(19) United States
(12) Patent Application Publication
(10) Pub. No.: US 2013/0169522 A1
(43) Pub. Date: Jul. 4, 2013

(54) HARD KEY AND VEHICLE TERMINAL USING THE SAME

(71) Applicants: Byung Nam Roh, Hwaseong (KR); Jae Seok Park, Hwaseong (KR)

(72) Inventors: Byung Nam Roh, Hwaseong (KR); Jae Seok Park, Hwaseong (KR)

(73) Assignee: HYUNDAI MOTOR COMPANY, Seoul (KR)

(21) Appl. No.: 13/525,578

(22) Filed: Jun. 18, 2012

(30) Foreign Application Priority Data
Dec. 28, 2011 (KR) 10-2011-0144721

(51) Int. Cl. G06F 3/01

(52) U.S. Cl. 345/156

(57) ABSTRACT

A disclosed is a vehicle terminal, which is capable of using hard keys configured to be arranged and modified according to a user's taste. In particular, the spatial arrangement of the hard keys may be changed, as well as their appearance.

### CROSS-REFERENCES TO RELATED APPLICATIONS

This application claims priority under 35 U.S.C. §119(a) to Korean patent application No. 10-2011-0144721 filed on Dec. 28, 2011, the disclosure of which is hereby incorporated in its entirety by reference.

### BACKGROUND OF THE INVENTION

1. Field of the Invention

The present invention relates to a hard key and a vehicle terminal using the same. More particularly, the present invention relates to technology capable of changing the arrangement of functional keys or key skins in hardware according to a user's preferences.

2. Description of the Related Art

Use of vehicle terminals such as car audio systems, GPS navigation systems, audio/video navigation (AVN) systems which are provided in vehicles, is increasing. Such vehicle terminals are operated through wither soft or hard keys. Hard keys are typically arranged in a group, and are produced with the same shape.

This type of arrangement is disadvantageous because it prevents a user from changing the key arrangement and/or key skin. Instead, a user is forced to use the vehicle terminals according to the key arrangement and key skin provided at the time of vehicle production, regardless of his or her tastes.

### SUMMARY OF THE INVENTION

The present invention provides a hard key and a vehicle terminal using the same, which are capable of maximizing the user's convenience by allowing the key location and key skin to be changed in the hardware according to a user's needs

According to an exemplary aspect of the present invention, a vehicle terminal is provided. The vehicle terminal includes hard keys for functions, and the configuration of the hard keys for specific functions may be altered by a user.

The vehicle terminal may include: a main body; a plurality of key sockets formed in the main body to have identical specifications; a plurality of hard keys having the same specifications as the plurality of key sockets, so that the plurality of hard keys may be inserted into the plurality of the sockets; a storage unit that stores programs for functions corresponding to the plurality of the hard keys; and a control unit that controls a program for a function corresponding to a selected hard key to be executed when a command request by the selected hared key is recognized. Each of the plurality of the key sockets may have a connection terminal to which each of the plurality of hard keys may be connected. When a command is input, the plurality of hard keys may allow different currents to be flowed therethrough.

The plurality of hard keys may be configured with resistors having different resistances. The plurality of hard keys may have different numbers of pins, or different arrangements of the pins with respect to each other. The plurality of key sockets may have connection terminals that vary depending on the number and/or arrangement of the pins of the plurality of hard keys. Each of the plurality of hard keys may be provided with an integrated circuit (IC) chip that outputs a control signal for performing a function corresponding to each of the plurality of hard keys. The function may include a function for at least one of a GPS navigation system, a car audio system, a telephone, an information inquiry system, and a user set up system.

According to another aspect of the present invention, a hard key is provided. The hard key may receive a command for executing a function of a functional terminal, and may be attachable to the functional terminal or detachable from the functional terminal regardless of a functional location of a key socket on the functional terminal. The hard key may allow at least one function, such as, for example, a name, a number, a skin, a letter, a font of numeral, and the like, to be configurable. The hard key may include resistors that have different resistance values according to their respective functions. The hard key may have different number of pins or arrangements of the pins according to the functions. The hard key may be provided with an IC chip that outputs a control signal for performing a function according to the function.

According to the forgoing invention, it is possible for the user to change the key arrangement and/or key skin of the vehicle terminal, thereby increasing the user's convenience and level of satisfaction.

The apparatuses and methods of the present invention have other features and advantages which will be apparent from or are set forth in more detail in the accompanying drawings, which are incorporated herein, and the following Detailed Description of the Invention, which together serve to explain certain principles of the present invention.

### BRIEF DESCRIPTION OF THE DRAWINGS

FIG. 1 is a view illustrating a configuration in which hard keys are arranged in a vehicle terminal according to an example of the present invention.

FIG. 2 is a view illustrating a detailed configuration of a vehicle terminal according to an exemplary embodiment of the present invention.

FIG. 3A is a view illustrating an example in which hard keys are arranged in the vehicle terminal according to a function according to an exemplary embodiment of the present invention.

FIG. 3B is a view illustrating an example in which radio free set keys are arranged in the vehicle terminal according to an exemplary embodiment of the present invention.

FIG. 3C is a view illustrating an example in which hard keys of fluorescence skin are arranged according to an exemplary embodiment of the present invention.

FIG. 4 is a view illustrating a detailed functional configuration of hard keys according to an exemplary embodiment of the present invention.

FIG. 5 is a view illustrating a detailed functional configuration of hard keys according to another exemplary embodiment of the present invention.

### DETAILED DESCRIPTION

Reference will now be made in detail to various embodiments of the present invention(s), examples of which are illustrated in the accompanying drawings and described below. Like reference numerals in the drawings denote like elements.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

In addition, in describing the elements of the exemplary embodiments of the present invention, the terms, first, second, A, B, (a), (b) and the like may used. Such terms merely are for distinction between the configured elements; the essence, the order, the sequence of the elements and the like are not limited by the terms. When described as that any element is “connected”, “coupled” or “accessed” to another element, it should be understood that it is possible that still another element may “connected”, “coupled” or “accessed” between the two elements as well as that the two elements are directly “connected”, “coupled” or “accessed” to each other.

The present invention uses the Bread Board principle of examining/confirming electronic/electric equipments by inserting and temporarily connecting an element when testing the electronic/electric equipments.

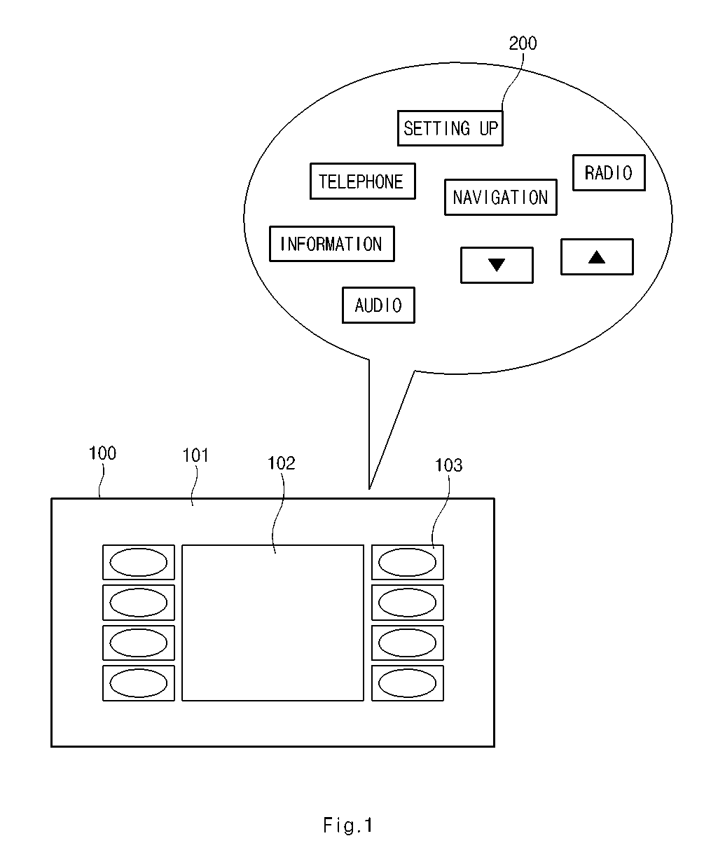

Referring to FIG. 1, a vehicle terminal 100 includes a main body 101, a display unit 102 that is formed at a front of the main body 101 and displays various information, a plurality of key sockets 103 that is formed in the front surface of the main body 102 and have the same specification, and a plurality of hard keys 200 that is inserted into the plurality of key sockets 103 corresponding thereto and have the same specification.

Since the plurality of key sockets 103 and the plurality of hard keys 200 have the same specification and correspond to each other, any hard keys may be inserted into any key sockets to be coupled therebetween. These key sockets are detachably coupled with the hard keys.

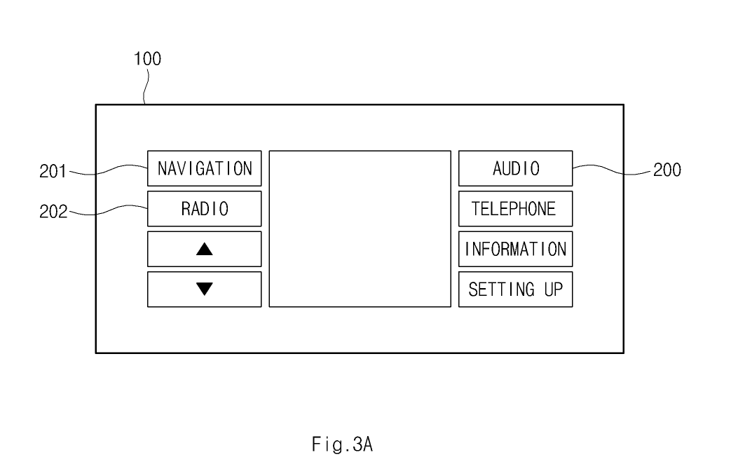

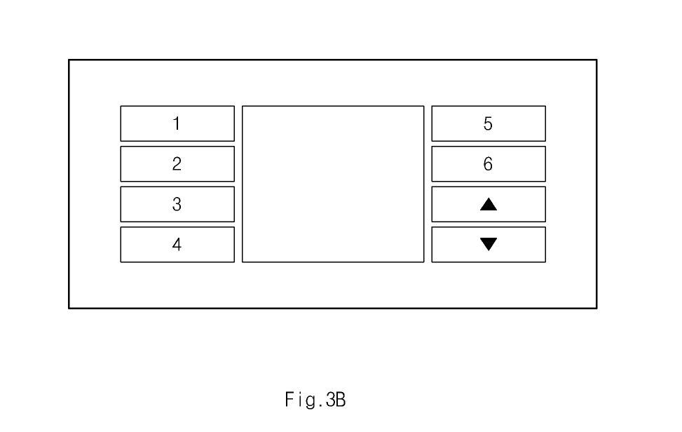

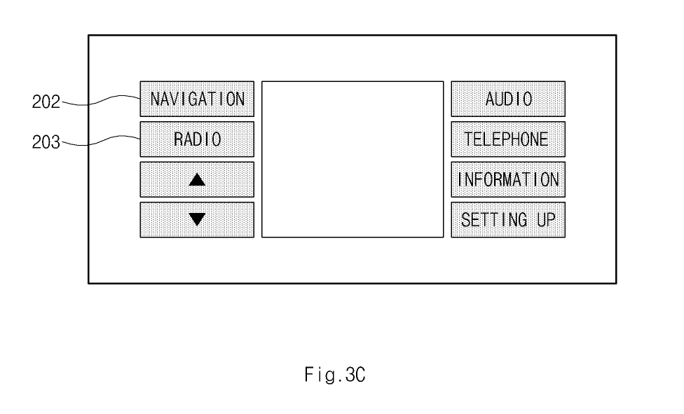

Accordingly, the user may couple the hard keys to the key sockets as shown in FIG. 3, such that a user's desired key is arranged at a user's desire location. Such coupling may be carried out by the user or at the after service (AS) center.

Here, if functions of the key sockets were performed according to the locations of the key sockets as found in the vehicle terminals of the conventional art, it would not be possible to perform an operation of the hard keys by merely changing the location of the hard keys.

Therefore, according to an exemplary embodiment of the present invention, different elements (such as, e.g., resistors, the number of the pins, and the like) are built in the plurality of hard keys 200, and the key sockets 103 are provided with connection terminals (not shown), which are connected to elements built in the hard keys 200. The different elements built in the hard keys 200 are configured to connect the connection terminals (not shown) installed in the key sockets 103. In addition, the main body 101 is provided with a storage unit such that a pre-designated function on a corresponding element may be performed when a hard key provided therein with the corresponding element is pressed. The elements may be resistors having different resistance from each other.

For example, when a first hard key provided therein with a first element is pressed, the vehicle terminal recognizes a signal generated from the element that is built into the first hard key and performs an appropriate function for the first hard key regardless of a state in which the first hard key is inserted into any key socket. For example, the hard key having a navigation function performs the navigation function no matter where the hard key is located in the vehicle terminal 100.

According to an exemplary embodiment of the present invention, it is possible for a user to customize the hard keys in accordance with the desired location that the user wants, thereby maximizing the user's convenience.

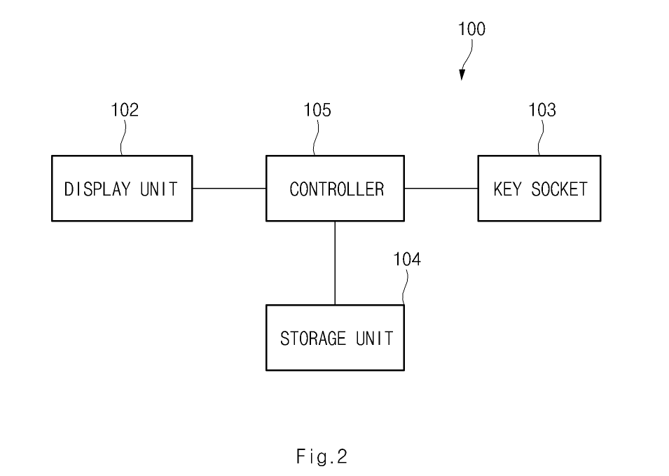

Referring to FIG. 2, the vehicle terminal 100 of the present invention includes a display unit 102, key sockets 103, a storage unit 104, and a control unit 105.

The display unit 102 displays information on the various functions that the vehicle terminal performs, and the key sockets 103 provides access to the hard keys 200. The storage unit 104 stores programs for functions and the control unit 105 recognizes a function on a corresponding command when inputting the command of the hard key 200 (pressing the hard key), and controls to execute a program on the recognized function.

According to the user's preference, the arrangement of the hard keys is changeable. For example, FIG. 3A is a view illustrating an example in which a user who mainly uses the radio or GPS navigation systems, may arrange the navigation key 201 and the radio key 202 at a left upper part; FIG. 3B is a view illustrating an example in which the user who mainly uses the radio will hear only the radio, arrange only free-set keys; and FIG. 3C is a view illustrating an example in which the user who mainly uses the radio and the audio system, arranges the radio key 202 and the audio key 203 at the left upper portion. As shown in FIGS. 3A to 3C, it is possible to change the skin of the hard key 200. That is, the user may decorate the hard keys 200 with a color, a font, and the like, as the user desires.

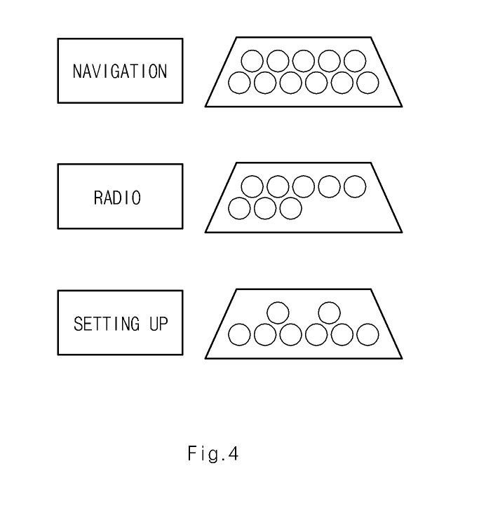

As shown in FIG. 4, the hard keys 200 may be classified according to their functions by changing the number or location of the pins. For example, as shown in FIG. 4, a navigation key may be configured to have eleven pins. Both the radio key and setting up key have eight pins, but the radio key and setting up key may also be classified by changing their pin arrangement.

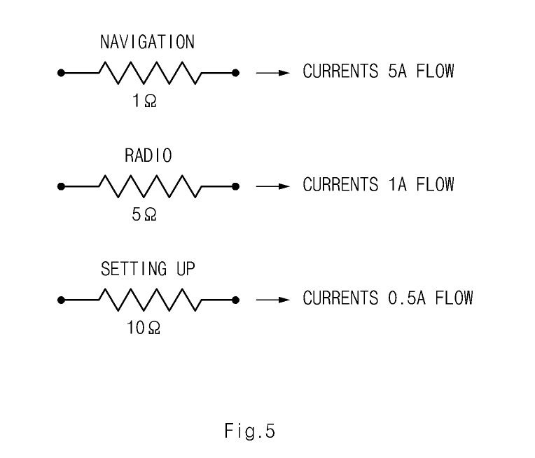

In addition, as shown in FIG. 5, the hard keys 200 may be configured such that their functions are classified by a difference of current or voltage by inserting resistors having different resistances from each other into the hard keys 200. For example, the functions may be classified by the differences of the currents that flow through the respective resistors by inserting a 1Ω resistor into a navigation key, a 5Ω resistor into a radio key, and a 10Ω resistor into a setting up key.

Although it is not shown, the plurality of hard keys 200 may be implemented so that an IC chip configured to output a specific signal for a function is built in each hard key, so that the navigation key outputs a first signal, the radio key outputs a second signal, the setting up key outputs a third signal, and the first to third signals are classified by a wavelength, a frequency, and the like of the signal.

The forgoing descriptions of the terms such as “include”, “comprise” or “have,” mean that the elements may be included, as long as there are no special descriptions to the contrary. Therefore, it should be interpreted that other elements are not be excluded therefrom but may be further included therein. Unless it is defined differently, all of the terms including technical or scientific terms have the meaning that is generally understood by ordinary persons skilled in the art. General terms as defined in the dictionary should be interpreted as having the meaning that is consistent with the context of the description of the related technology.

Furthermore, the control logic of the present invention may be embodied as non-transitory computer readable media on a computer readable medium containing executable program instructions executed by a processor, controller or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or over a Controller Area Network (CAN).

Although the above exemplary embodiment is described as using a plurality of units to perform the above process, it is understood that the above processes may also be performed by a single controller or unit.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A vehicle terminal, comprising:
a main body,
a display unit,
a plurality of key sockets, wherein the plurality of key sockets are configured substantially similarly, and
a plurality of hard keys having associated functions, wherein each of the plurality of hard keys is configured to correspond to a particular key socket.

2. The vehicle terminal of claim 1, wherein each of the plurality of hard keys is configured to correspond to any key socket among the plurality of key sockets.

3. The vehicle terminal of claim 2, wherein a user configures which hard key corresponds to a particular key socket.

4. The vehicle terminal of claim 1, further comprising:
a storage unit configured to store one or more programs for executing the functions corresponding to each hard key among the plurality of the hard keys; and a control unit that controls the one or more programs for executing the functions corresponding to a selected hard key to be executed when a command request by the selected hard key is received and recognized.

5. The vehicle terminal of claim 2, wherein each of the plurality of the key sockets has a connection terminal to which each of the plurality of the hard keys is connected.

6. The vehicle terminal of claim 4, wherein the control unit allows different currents to flow through the plurality of hard keys when a command is received.

7. The vehicle terminal of claim 6, wherein each hard key among the plurality of hard keys is configured with a resistor having a different resistance.

8. The vehicle terminal of claim 6, wherein each hard key among the plurality of hard keys has a different number of pins, or a different arrangement of pins.

9. The vehicle terminal of claim 8, wherein the plurality of key sockets has connection terminals configured to correspond to the number, or arrangement, of the pins on each hard key amount the plurality of hard keys.

10. The vehicle terminal of claim 6, wherein each of the plurality of hard keys comprises an integrated circuit (IC) chip that outputs a control signal for performing a function corresponding to each of the plurality of hard keys.

11. The vehicle terminal of claim 10, wherein the function is selected from the group consisting of a navigation function, a radio function, an audio function, a telephone function, an information inquiry function, and set up function.

12. A hard key, comprising:
a plurality of pins,
a resistor, and
an integrated circuit (IC) chip, wherein the IC chip is configured to output a control signal for performing a function associated with the hard key

13. The hard key of claim 12, wherein the plurality of pins have a number and/or arrangement that varies according to the function of the hard key.

14. The hard key of claim 12, further comprising an identifier having at least one field selected from the group consisting of a name, a number, a skin, a letter, a font, and any combination thereof.

15. The hard key of claim 14, wherein the at least one field is configured by a user.

16. A non-transitory computer readable medium containing program instructions executed by a processor or controller, the computer readable medium comprising:
program instructions that receive a command request from one or more hard keys; and
program instructions that execute a command corresponding to the command request from the one or more hard keys.
